(19) United States
(12) Patent Application Publication
(10) Pub. No.: US 2024/0248283 A1
(43) Pub. Date: Jul. 25, 2024

(54) Lens Assembly and Thermal Correction for Machine Vision System

(71) Applicant: Cognex Corporation, Natick, MA (US)

(72) Inventors: Esther Oteo Lozano, Vaals (NL); Torsten Kempf, III, Aachen (DE); Nicole Dippel, Aachen (DE); Francisco Azcona Guerrero, Aachen (DE); Andreas Weber, Aachen (DE); Laurens Nunnink, Simpleveld (NL)

(21) Appl. No.: 18/417,651

(22) Filed: Jan. 19, 2024

Related U.S. Application Data
(60) Provisional application No. 63/440,343, filed on Jan. 20, 2023.

(51) Int. Cl. G02B 7/28; G02B 3/14; G02B 7/02

(52) U.S. Cl. CPC G02B 7/28; G02B 3/14; G02B 7/021; G02B 7/026

(57) ABSTRACT

A modular lens assembly for a machine vision system includes a lens housing, a liquid lens disposed within the lens housing, a solid lens element disposed within the lens housing, and a lens processor device disposed within the lens housing and coupled to the liquid lens. The lens processor device may be configured to determine a control signal to control the liquid lens.

### CROSS-REFERENCE TO RELATED APPLICATIONS

This application is based on, claims priority to, and incorporates herein by reference in its entirety U.S. Ser. No. 63/440,343, filed Jan. 20, 2023, and entitled “Lens Assembly and Thermal Correction For Machine Vision System.”

### STATEMENT REGARDING FEDERALLY SPONSORED RESEARCH

N/A

### BACKGROUND

The present technology relates to imaging systems, including machine vision systems that are configured to acquire and analyze images of objects or symbols (e.g., barcodes).

Machine vision systems are generally configured for use in capturing images of objects or symbols and analyzing the images to identify the objects or decode the symbols. Accordingly, machine vision systems generally include one or more devices for image acquisition and image processing. In conventional applications, these devices can be used to acquire images, or to analyze acquired images, such as for the purpose of decoding imaged symbols such as barcodes or text. In some contexts, machine vision and other imaging systems can be used to acquire images of objects that may be larger than a field of view (FOV) for a corresponding imaging device and/or that may be moving relative to an imaging device.

### SUMMARY

Generally, embodiments if the technology can provide interchangeable lens assemblies including lens assembly processing components for machine vision systems. For example, the lens assembly can be removably attached to different imaging devices (or image sensors or readers) where the imaging devices include separate image sensor processing components. Thus, some embodiments can allow quick and easy transitions between different lens assemblies for different types of operations.

In accordance with an embodiment of the technology, a modular lens assembly for a machine vision system includes a lens housing, a liquid lens disposed within the lens housing, a solid lens element disposed within the lens housing, and a lens processor device disposed within the lens housing and coupled to the liquid lens. The lens processor device may be configured to determine a control signal to control the liquid lens.

In some embodiments, the lens processor device is further configured to determine at least one of mechanical compensation, electrical compensation, or thermal compensation for the control of the liquid lens. In some embodiments, the modular lens assembly further includes a temperature sensor disposed within the lens housing and proximate to the liquid lens. In some embodiments, determining the thermal compensation can include correcting thermal drift of the liquid lens. In some embodiments, the lens housing is configured to be coupled to an image sensor assembly that includes an image sensor assembly housing, an image sensor, and an image sensor assembly processor device disposed within the image sensor assembly housing. The control signal can be a current applied to the liquid lens. In some embodiments, the control signal is determined by the lens processor device based on a predetermined focus for the liquid lens. In some embodiments, the control signal is determined by the lens processor device based on a working distance to an object. In some embodiments, the control signal is determined based on at least one of the mechanical compensation, electrical compensation, or thermal compensation. In some embodiments, the modular lens assembly further includes a cable connected to the liquid lens and the lens processor device, and the temperature sensor is positioned on the cable proximate a connection point between the cable and the liquid lens. In some embodiments, the lens housing includes a barrel having an outer surface, and a calibration ring disposed around the outer surface of the barrel and configured to cause linear movement of the barrel when the calibration ring is rotated. In some embodiments, the modular lens assembly further includes a positioning element coupled to the barrel and configured to maintain a position of the barrel. In some embodiments, the lens processor device is configured to perform a diagnostic function for the liquid lens. In some embodiments, the diagnostic function comprises generating an error signal in response to detection of an open circuit or a short circuit corresponding to the liquid lens.

In accordance with another embodiment of the technology, a method for correcting thermal drift of a liquid lens in a lens assembly for a machine vision system includes receiving a distance to an object, receiving a temperature measurement for the liquid lens, determining a change in temperature for the liquid lens, determining a lens focus adjustment using a thermal model of the machine vision system, and adjusting a focal length of the liquid lens based on the lens focus adjustment. The thermal model can include mechanical and electrical parameters of the machine vision system.

In some embodiments, the thermal model is given by:

$$\frac{d {P}_{s y s}}{d T} = {\sum }_{i = 0}^{n} {k}_{i} {x}^{i} ,$$

where dP_{sys} is an optical power difference of the machine vision system relative to a reference optical power, dT is the change in temperature for the liquid lens relative to a reference temperature, kᵢ is a set of coefficients modelling the interaction between a system optical power, a temperature, and an input signal for the liquid lens, and x is a discrete input for the liquid lens at a given optical power. In some embodiments, adjusting the focal length of the liquid lens includes determining a control current based on the lens focus adjustment, and applying the control current to the liquid lens. In some embodiments, determining the lens focus adjustment using the thermal model includes determining the optical power difference dP_{sys} using the thermal model; and comparing the determined optical power difference dP_{sys} to a predetermined calibration curve for the liquid lens to identify the lens focus adjustment. In some embodiments, the predetermined calibration curve includes a relationship between current and optical power for the liquid lens and the predetermined calibration curve is determined using a plurality of distances that fit non-linear behavior.

In accordance with another embodiment of the technology, a lens assembly for a machine vision system includes a lens housing that may include a barrel having an outer surface and a calibration ring disposed around the outer surface of the barrel. The calibration ring may be configured to cause linear movement of the barrel when the calibration ring is rotated. The lens assembly may further include a plurality of lens elements disposed within the barrel and positioning element coupled to the barrel and configured to maintain a position of the barrel.

In some embodiments, the positioning element comprises a plurality of springs. In some embodiments, the calibration ring is configured to adjust a back focal length. In some embodiments, the plurality of lens elements includes a solid lens element. In some embodiments, the lens assembly further includes a locker ring disposed around the calibration ring, a locking apparatus, and an O-ring disposed between the calibration ring and the locker ring. In some embodiments, the locking apparatus includes a first visual indicator on the locker ring, a catch on the locker ring, a second visual indicator on the calibration ring, and a recess positioned on the calibration ring. In some embodiments, the locker ring is configured to be moved linearly to engage the calibration ring in response to an alignment of the first visual indicator and the second visual indicator. In some embodiments, the catch on the locker ring is configured to engage the recess on the calibration ring in response to the locker ring moving linearly. In some embodiments, rotation of the locker ring drives rotation of the calibration ring when the locker ring is engaged with the calibration ring. In some embodiments, the locker ring is configured to be moved linearly to disengage from the calibration ring in response to an alignment of the first visual indicator and the second visual indicator. In some embodiments, the catch is configured to disengage from the recess on the calibration ring in response to the locker ring moving linearly. In some embodiments, the locker ring is configured to rotate separately from the calibration ring in response to the locker ring being disengaged from the calibration ring. In some embodiments, the plurality of lens elements includes a liquid lens.

In accordance with another embodiment of the technology, a system for correcting thermal drift of a liquid lens in a lens assembly for a machine vision system includes a liquid lens and a processor device coupled to the liquid lens. The processor device is configured to receive a distance to an object, receive a temperature measurement for the liquid lens, determine a change in temperature for the liquid lens, determine a lens focus adjustment using a thermal model of the machine vision system, and adjust a focal length of the liquid lens based on the lens focus adjustment. The thermal model can include mechanical and electrical parameters of the machine vision system. In some embodiments, the system further includes a lens housing, and the liquid lens and the processor device are disposed within the lens housing.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1A is a perspective view of a lens assembly for a machine vision system in accordance with an embodiment of the technology;

FIG. 1B is a perspective view of the lens assembly of FIG. 1A in accordance with an embodiment of the technology;

FIG. 2 is a cross-sectional view of the lens assembly of FIGS. 1A and 1B in accordance with an embodiment of the technology;

FIG. 3 is a partially exploded view of the lens assembly of FIGS. 1A and 1B in accordance with an embodiment of the technology;

FIGS. 4A and 4B illustrate adjustment of a barrel of the lens assembly of FIGS. 1A and 1B in accordance with an embodiment of the technology;

FIG. 5 is a perspective view of a calibration ring, a locker ring and a locking apparatus in accordance with an embodiment of the technology;

FIGS. 6A and 6B illustrate a locking apparatus of a lens assembly in an unlocked position in accordance with an embodiment of the technology;

FIGS. 7A and 7B illustrate a locking apparatus of a lens assembly in a locked position in accordance with an embodiment of the technology;

FIG. 8A is a perspective view of a lens assembly for a machine vision system in accordance with an embodiment of the technology;

FIG. 8B is a perspective view of the lens assembly of FIG. 8A in accordance with an embodiment of the technology;

FIG. 9 is a cross-sectional view of the lens assembly of FIGS. 8A and 8B in accordance with an embodiment of the technology;

FIG. 10 shows a liquid lens and lens processor device of the lens assembly of FIGS. 8A and 8B in accordance with an embodiment of the technology;

FIG. 11 is a block diagram of a machine vision system including a modular lens assembly in accordance with an embodiment of the technology;

FIG. 12 is a block diagram of a lens processor and an image sensor assembly processor of the machine vision system of FIG. 11 in accordance with an embodiment of the technology;

FIG. 13 illustrates a method for correcting thermal drift of a liquid lens in a lens assembly for a machine vision system in accordance with an embodiment of the technology; and

FIG. 14 is an example calibration curve for a liquid lens in accordance with an embodiment.

### DETAILED DESCRIPTION

Vision systems may be used in a variety of applications including reading and decoding IDs (e.g., barcodes), logistics (e.g., presentation mode), inspecting objects and surfaces, alignment of objects during assembly, measurement, factory automation, and any other operations in which visual data is acquired and interpreted for use in further processes. ID (e.g., barcode) readers are generally configured to track and sort objects, including along a line (e.g., a conveyor) in manufacturing and logistics operations. The ID reader, or more typically, a plurality (constellation) of readers can be positioned over the line (or otherwise) at an appropriate viewing angle(s) to acquire any expected ID codes on the face(s) of respective objects as they each move through the field of view. The ID reader can also be provided in a handheld configuration that allows the user to move from object to object, for example, on an inspection floor and vary the distance or relative angle between the reader and object surface at will. More generally, the focus distance of the ID reader with respect to the object can vary, depending on the placement of the reader with respect to the line and the size of the object.

Vision systems for inspection are generally configured to capture an image of an object (e.g., a component or part) on a production or assembly line, processing the image to determine if the object meets a predefined criteria (e.g., one or more expected features are present), and report the inspection results. Such machine vision systems may aid in the inspection, assembly, and/or handling of various types of articles, parts, and devices, including automotive parts (e.g., fuses gaskets, and spark plugs), electrical components (e.g., connector pins, keyboards, LED, LCD displays), medical and pharmaceutical products (e.g., disposable test kits, syringes, needles, and date-lot codes), and consumer products (e.g., razor blades and floppy disks).

Generally, different configurations of machine vision systems, such as with different orientations or types of imaging sensors, different imaging lenses, or other optical modules (e.g., aimers, distance finders, etc.) may be needed to optimally perform specific machine vision tasks. For example, as noted above, machine vision systems can be configured to capture images of an object, analyze the images to identify relevant characteristics, actions, and so on, and instruct various devices (e.g., manufacturing or sorting device) based upon the image analysis. In this context, an optimal type or orientation of an imaging sensor or an optimal type of lens or other optical device may be directly linked to the relative orientation of an object to be captures, the particular type of object or environment (e.g., relative to lighting considerations) or other factors. Accordingly, it may be useful for operators to be able to easily swap particular imaging sensors, lenses, or other optical devices for use with a particular machine vision system.

Some conventional imaging systems can be configured for capturing a specific object or for performing predetermined processes under particular conditions, with optical devices that are fixed in limited, predetermined and sometimes non-changeable orientations. Correspondingly, some conventional machine vision systems may be generally equipped to receive and operate with only a single (and single type of) optical device at any given time. Further, while some conventional systems can allow switching of optical devices, such as via the interchange of lenses with similar mounting configurations, these systems may not be particularly adaptable to accommodate wide varieties of operations and operating conditions.

Among other aspects, the preset disclosure describes a modular lens assembly (and related method) for a machine vision system that includes a lens housing having a calibration ring that may be used to adjust the position of lenses in the lens assembly to, for example, adjust the back focal length of the lens assembly. In some embodiments, the lenses are disposed in a barrel of the lens housing and the calibration ring is disposed around an outer surface of the barrel. In some embodiments, the barrel and the calibration ring can be configured to cause liner movement of the barrel (and thus the lenses within the barrel) when the calibration ring is rotated. In some embodiments, the barrel and the calibration ring can include corresponding thread elements that cause the barrel to move linearly when the calibration ring is rotated. In some embodiments, the lens assembly can include a liquid lens. In some embodiments, the lens assembly can include solid lens elements. In some embodiments, the lens assembly can include both solid lens elements and a liquid lens. Advantageously, the lens assembly can also include one or more positioning elements coupled to the barrel to maintain a position of the barrel and to prevent backlash.

Advantageously, in some embodiments, the lens assembly can include solid lens elements and also can include a locking apparatus to, for example, prevent unintentional movement of the barrel and lenses from a desired position. In some embodiments, a locker ring can be positioned around the calibration ring. The locking apparatus can include one or more recesses on an outer surface (or circumference) of the calibration ring and one or more corresponding catches on an inner surface of the locker ring. In some embodiments, a visual indicator may be provided for each recess on the calibration ring and a visual indicator may be provided for each catch on the locker ring. In an unlocked position of the locking apparatus, the locker ring may be selectively engaged with the calibration ring and rotation of the locker ring may be used to drive rotation of the calibration ring to move the barrel of the lens assembly linearly and adjust the position of the barrel and the solid lens elements disposed within the barrel. In some embodiments, the locker ring may be engaged with the calibration ring by moving the locker ring linearly so that each catch on the locker ring is pushed into (or engages) a corresponding recess on the calibration ring. In a locked position of the locking apparatus, the locker ring may be selectively disengaged from the calibration ring so that rotation for the locker ring does not drive rotation of the calibration ring. Accordingly, the position of the barrel of the lens assembly may be locked in its current position and the locker ring may be rotated separately from the calibration ring without driving rotation of the calibration ring. In some embodiments, the locker ring may be disengaged from the calibration ring by moving the locker ring linearly so that each catch on the locker ring moves out of (or disengages) from the corresponding recess on the calibration ring. In some embodiments, the locker ring can be moved linearly to engage or disengage the calibration ring when an indicator on the calibration ring is aligned with an indicator on the locker ring.

In another aspect, the present disclosure describes a modular lens assembly that includes a lens housing, and a liquid lens and a lens processor disposed within the lens housing. The modular lens assembly can be configured to be removably and interchangeably attached to different image sensor assemblies (or cameras). The lens processor can advantageously be configured to perform various tasks or functions including, but not limited to, determining a thermal correction for the liquid lens and controlling the liquid lens. For example, the lens processor can be configured to apply a current to adjust the focal distance and optical power of the liquid lens. In yet another aspect, the present disclosure describes a method for correcting thermal drift of a liquid lens in a lens assembly for a machine vision system. In some embodiments, a lens focus correction (or adjustment) may be determined using a thermal model of the full machine vision system. Accordingly, the thermal model advantageously can be configured as a statistical model of the full system behavior that includes system parameters as well as parameters of the liquid lens.

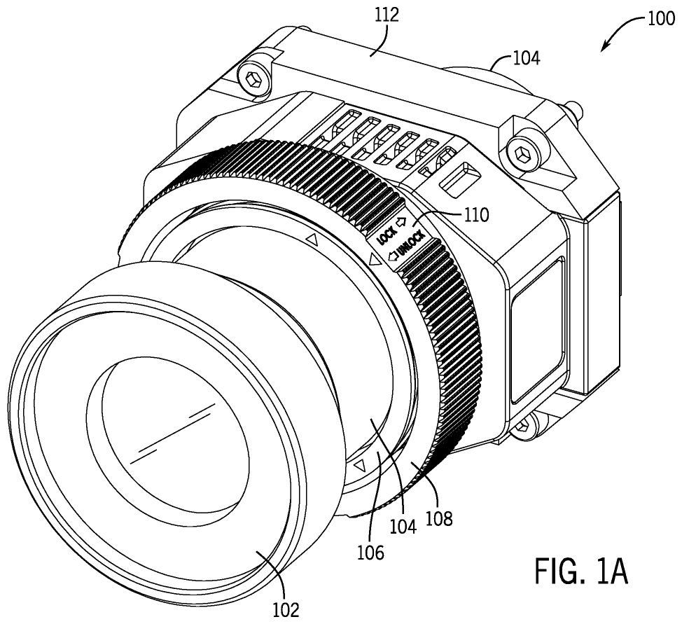

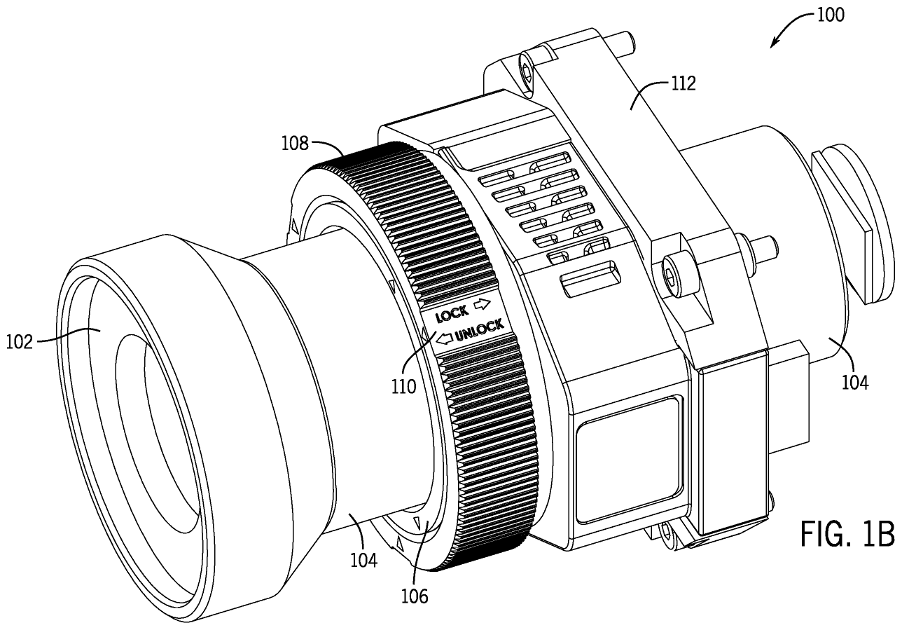

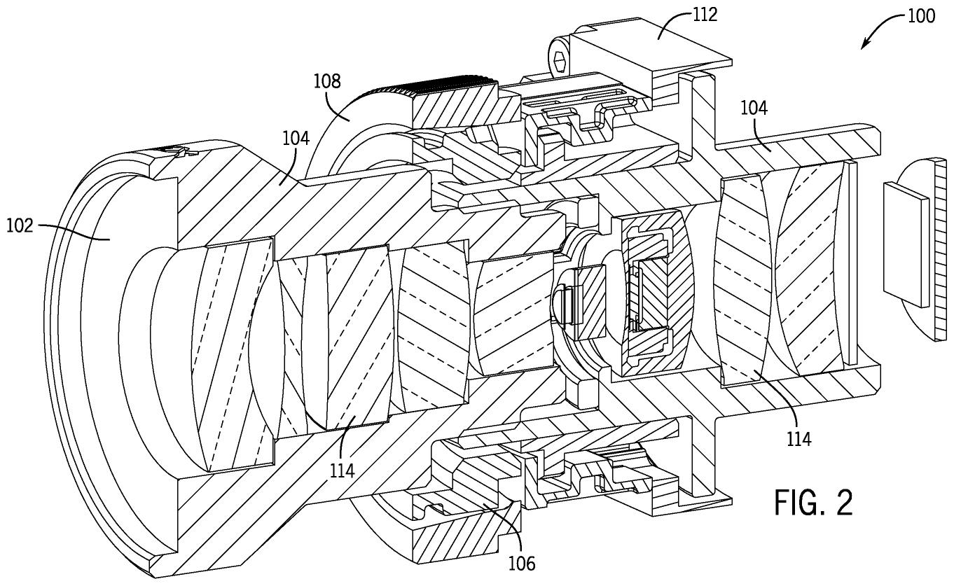

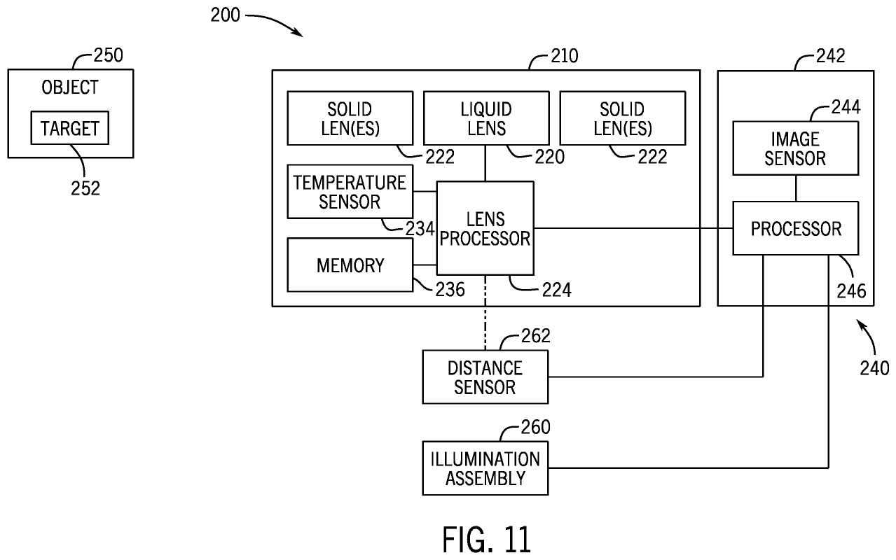

FIG. 1A is a perspective view of a lens assembly for a machine vision system in accordance with an embodiment of the technology and FIG. 1B is a perspective view of the lens assembly of FIG. 1A in accordance with an embodiment of the technology. The lens assembly 100 in FIGS. 1A and 1B can include a cover 102, a barrel 104, a calibration ring 106, a locker ring 108 and a flange (e.g., a C-mount flange) 112. The cover 102, barrel 104, calibration ring 106, locker ring 108 and flange 112 may be elements of a housing for the lens assembly 100. The barrel 104 may be configured to house solid lens elements 114 (e.g., glass lens elements) as shown in FIG. 2, discussed further below. In some embodiments, the barrel 104 can have a cylindrical shape. The cover 102 can be attached to a first end of the barrel 104 and may be configured to be positioned in front of the lens elements 114 (shown in FIG. 2) disposed in the barrel 104. The flange 112 can be disposed around the barrel 104 proximate to a second end of the barrel 104 and may be configured to be mounted to an image sensor assembly (e.g., image sensor assembly 240 discussed further below with respect to FIG. 11). Advantageously, lens assembly 100 can be modular and may be interchangeably attached to different image sensor assemblies.

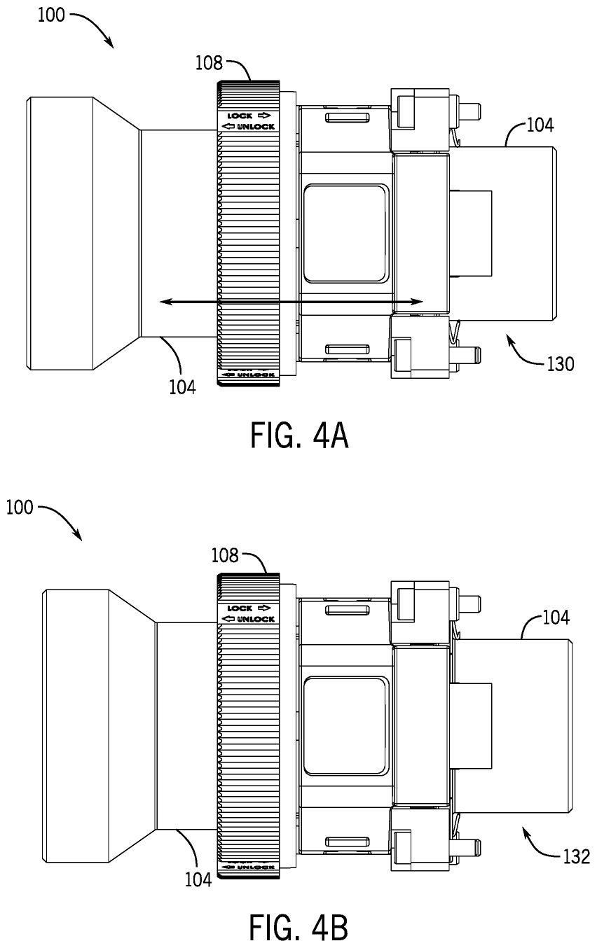

The calibration ring 106 can be disposed around the barrel 104 and may be configured to cause linear movement of the barrel 104 when the calibration ring 106 is rotated about the barrel 104, as discussed further below with respect to FIGS. 4A and 4B. Advantageously, rotation of the calibration ring 106 can be configured to only cause linear movement of the barrel so that the lens elements 114 within the barrel do not rotate as the calibration ring 106 is rotated and the barrel 104 moves. In some embodiments, adjustment of the barrel 104 (and solid lens elements disposed within the barrel 104) may be used to adjust and calibrate, for example, the back focal length of the lens assembly 100. In some embodiments, the barrel 104 and the calibration ring 106 may include corresponding thread elements that causes the barrel 104 to move linearly when the calibration ring 106 is rotated.

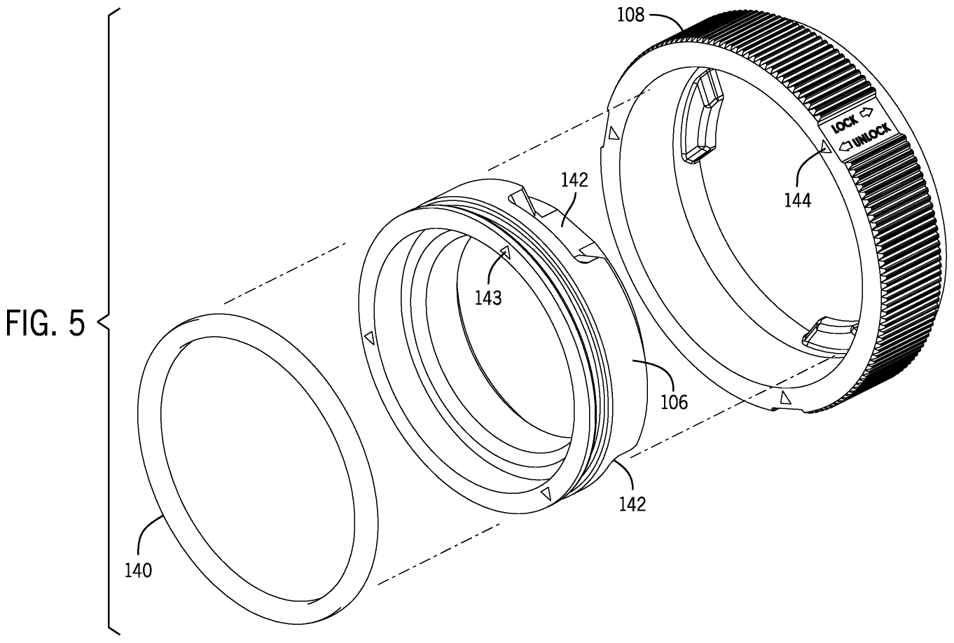

The locker ring 108 can be disposed around the calibration ring 106 and may be configured to selectively engage the calibration ring 106. Advantageously, the lens assembly 100 can also include a locking apparatus 110 as described further below with respect to FIGS. 5-7B. In some embodiments, in a first configuration (e.g., an unlocked position), the locker ring 108 may be selectively engaged with the calibration ring 106, rotation of the locker ring 108 may be used to drive rotation of the calibration ring 106 to move the barrel 104 linearly and adjust the position of the barrel 104 and the lens elements 114 (shown in FIG. 2) disposed within the barrel 104. In some embodiments, in a second configuration (e.g., a locked position), the locker ring 108 may be selectively disengaged from the calibration ring 106 so that rotation for the locker ring 108 does not drive rotation of the calibration ring 106. Accordingly, the position of the barrel 104 may be locked in its current position and the locker ring 108 may be rotated separately from the calibration ring 106 without driving rotation of the calibration ring 106 and, therefore, without causing movement of the barrel 104. In addition, locking the barrel 104 in the desired position can prevent movement of the barrel 104 and the lens elements 114 as a result of, for example, vibration of the lens assembly 100 caused by the environment in which the lens assembly (e.g., as part of a machine vision system) is located.

FIG. 2 is a cross-sectional view of the lens assembly of FIGS. 1A and 1B in accordance with an embodiment of the technology. It should be noted that the depicted arrangement of components is illustrative of a wide range of layouts and component types. This illustration is, thus, provided to teach a possible arrangement of components that provide the functions of the illustrative embodiment, although other embodiments can exhibit other configurations. As mentioned above, lens assembly 100 can include a cover 102, a barrel 104, a calibration ring 106, a locker ring 108 and a flange 112. In some embodiments, a plurality of solid lens elements 114 (e.g., glass) may be disposed in the barrel 104 and can be attached or mounted to the barrel 104. The cover 102 can be positioned on a first end of the barrel 104 and in front of the plurality of solid lens elements 114. The flange 112 can be disposed around the barrel 104 proximate to a second end of the barrel 104.

As mentioned above, the calibration ring 106 can be disposed around the barrel 104 and may be configured to cause linear movement of the barrel 104 and the solid lens elements 114 disposed within the barrel 104 when the calibration ring 106 is rotated about the barrel 104. Advantageously, the plurality of solid lens elements 114 do not rotate as the barrel 104 and the solid lens elements 114 move linearly as the calibration ring 106 is rotated about the barrel. In some embodiments, adjustment of the barrel 104 (and solid lens elements disposed within the barrel 104) may be used to adjust and calibrate, for example, the back focal length of the lens assembly 100. In some embodiments, the barrel 104 and the calibration ring 106 may include corresponding thread elements that causes the barrel 104 to move linearly when the calibration ring 106 is rotated. The locker ring 108 may be disposed around the calibration ring 106 and may be configured to drive the rotation of the calibration ring 106 when the locker ring 108 is engaged with the calibration ring 106. In some embodiments, the calibration ring 106 and the locker ring 108 may include components that form a locking apparatus that may be configured to, for example, lock the barrel 104 (and the plurality of lens elements 114) in a desired position. In some embodiments, when the lens assembly is mounted to an image sensor assembly, rotation of the calibration ring 106 can linearly move the barrel 104 (and the plurality of lens elements 114) toward and away from an image sensor in the image sensor assembly.

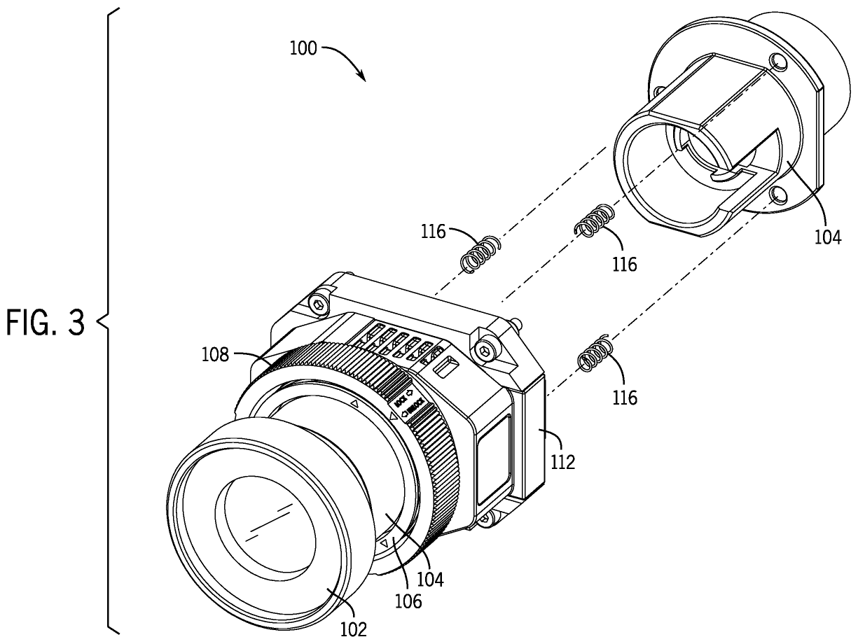

FIG. 3 is a partially exploded view of the lens assembly of FIGS. 1A and 1B in accordance with an embodiment of the technology. In some embodiments, the lens assembly 100 can include one or more positioning elements 116 that may be configured to maintain the position of the barrel 104, e.g., to ensure the barrel 104 is in the correct position, to prevent backlash. In some embodiments, the positioning elements 116 may be springs as shown in FIG. 3. As illustrated in FIG. 3, in some embodiments, the positioning elements 116 may be mounted to the barrel 104. While three positioning elements 116 are shown in FIG. 3 it should be understood that fewer or more positioning elements 116 may be used.

As mentioned above, the calibration ring 106 may be configured to cause linear movement of the barrel 104 when the calibration ring 106 is rotated about the barrel 104. FIGS. 4A and 4B illustrate adjustment of a barrel of the lens assembly of FIGS. 1A and 1B in accordance with an embodiment of the technology. In FIG. 4A, the barrel 104 of the lens assembly 100 is shown in a first position 130. In some embodiments, as discussed above, a locker ring 108 may be disposed around the calibration ring 106 and may be configured to drive rotation of the calibration ring 106 when the locker ring 108 is engaged with the calibration ring 106 (e.g., an unlocked position). By rotating the calibration ring 106 (e.g., by rotating the locker ring 108) about the barrel 104, the barrel 104 may be moved linearly, for example, to a second position 132 shown in FIG. 4B. In some embodiments, when the lens assembly 100 is mounted to an image sensor assembly, the linear movement of the barrel 104 (and the solid lens elements 114 disposed within the barrel 104) may be towards and away from an image sensor in the image sensor assembly. For example, as illustrated in FIGS. 4A and 4B, rotation of the calibration ring 106 (e.g., by using locker ring 108) moves a second end of the barrel 104 further past the flange 112. In some embodiments, adjustment of the barrel 104 (and solid lens elements disposed within the barrel 104) may be used to adjust and calibrate, for example, the back focal length of the lens assembly 100.

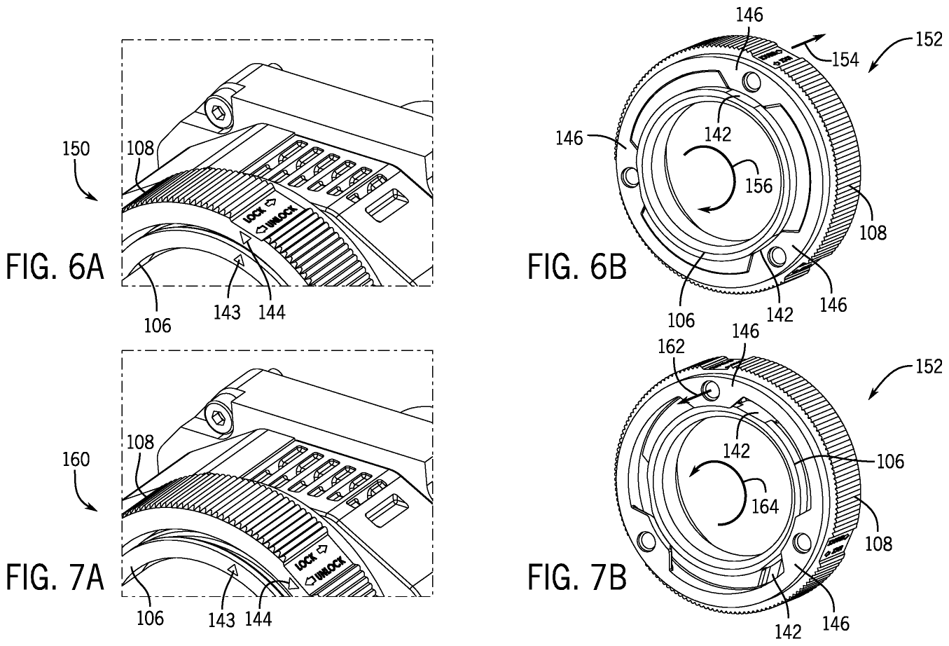

As mentioned above, in some embodiments, the lens assembly 100 may include a locking apparatus (e.g., locking apparatus 110 shown in FIGS. 1A and 1B). FIG. 5 is a perspective view of a calibration ring, a locker ring and a locking apparatus in accordance with an embodiment of the technology. In some embodiments, the locking apparatus may include one or more recesses 142 positioned around an outer surface (or circumference) of the calibration ring 106. In some embodiments, if more than one recess 142 is included on the calibration ring 106, the recesses 142 may be spaced apart from one another around the outer surface (or circumference) of the calibration ring 106 as illustrated in FIG. 5. In some embodiments, the calibration ring 106 may include three recesses 142. While two recesses are shown in FIG. 5, it should be understood that fewer or more recesses 142 may be provided on the outer surface of the calibration ring 106. The locking apparatus may also include one or more catches (not shown) on an inner surface of the locker ring 108, for example, catches 146 shown in FIGS. 6B and 7B. In some embodiments, the number of catches 146 on the locker ring 108 can be the same as the number of recesses 142 on the calibration ring 106. In some embodiments, if more than one catch 146 is included on the locker ring 108, the catches 146 may be spaced apart from one another around the inner surface of the locker ring 108. The locking apparatus may also include one or more visual indicators 143 on the calibration ring 106 and one or more visual indicators 144 on the locker ring 108. For example, in some embodiments, the visual indicators 143, 144 may be arrows as shown in FIG. 5. In some embodiments, an indicator 143 on the calibration ring may be aligned with (or correspond with) each recess 142 and an indicator 144 on the locker ring 108 may be aligned with (or correspond with) each catch 146 (shown in FIGS. 6B and 7B) on the locker ring 108. In some embodiments, an O-ring 140 may be positioned between the calibration ring 106 and the locker ring 108. The O-ring 140 may be configured to prevent the catches 146 (shown in FIGS. 6B and 7B) on the locker ring 108 from unintentionally engaging with a corresponding recess 142 on the calibration ring 106. Accordingly, the O-ring can be used to help hold the locker ring 108 in the locked position. As mentioned above, locking the barrel 104 in the desired position, prevents movement of the barrel 104 and the lens elements 114 as a result of, for example, vibration of the lens assembly 100 caused by the environment in which the lens assembly (as part of a machine vision system) is located.

In some embodiments, the locking apparatus may be selectively placed in an unlocked or locked position (e.g., by an operator) by aligning an indicator 144 on the calibration ring (i.e., corresponding to a recess 142) and an indicator 144 on the locker ring 108 (i.e., corresponding to a catch 146) and moving the locker ring 108 in a linear direction to either engage or disengage each catch 146 on the locker ring 108 with a corresponding recess 142 on the calibration ring 106. FIGS. 6A and 6B illustrate a locking apparatus of a lens assembly in an unlocked position in accordance with an embodiment of the technology. In FIG. 6A, the locking apparatus may be placed in an unlocked position 150 by aligning an indicator 143 on the calibration ring 106 with an indicator 144 on the locker ring 108. When the indicator 143 on the calibration ring 106 is aligned with an indicator 144 on the locker ring 144, each recess 142 on the calibration ring 106 may be aligned with a corresponding catch 146 on the locker ring 108. FIG. 6B shows a back (or rear) side 152 of the calibration ring 106 and the locker ring 108 when the indicators 143, 144 are aligned and thus the recess(es) 142 on the calibration ring 106 are aligned with the catch(es) 146 on the locker ring 108. The locker ring 108 may then be moved linearly as indicated by arrow 154, for example, in a direction towards the cover 102 and away from the flange 112 of the lens assembly 100, so that the catch(es) 146 are pushed into and engage the corresponding recess(es) 142. For example, the locker ring 108 may be moved in the direction 154 manually by an operator. In the unlocked position, the locker ring 108 may then be rotated (e.g., by an operator) as indicated by arrow 156 to drive rotation of the calibration ring 106 to move the barrel 104 linearly and adjust the position of the barrel of the lens assembly 100 and the lens elements 114 (shown in FIG. 2) disposed within the barrel.

FIGS. 7A and 7B illustrate a locking apparatus of a lens assembly 100 in a locked position in accordance with an embodiment of the technology. The locking apparatus may be placed in a locked position 160 by moving the locker ring 108 in the unlocked position linearly as indicated by arrow 162 (shown in FIG. 7B), for example, in a direction away from the cover 102 and towards the flange 112 of the lens assembly 100 so that the catch(es) 146 are pushed out of and disengaged from the corresponding recess(es) 142. For example, the locker ring 108 may be moved in the direction 162 manually by an operator. FIG. 7B shows a back (or rear) side 152 of the calibration ring 106 and the locker ring 108 when the locking apparatus is placed in a locked position 160. In the locked position 160, in some embodiments, the locker ring 108 does not drive rotation of the calibration ring 106. Accordingly, the position of the barrel may be locked in its current position and the locker ring 108 may be rotated separately from the calibration ring 106 (as indicated by arrow 164) without driving rotation of the calibration ring 106 and, therefore, without causing movement of the barrel 104.

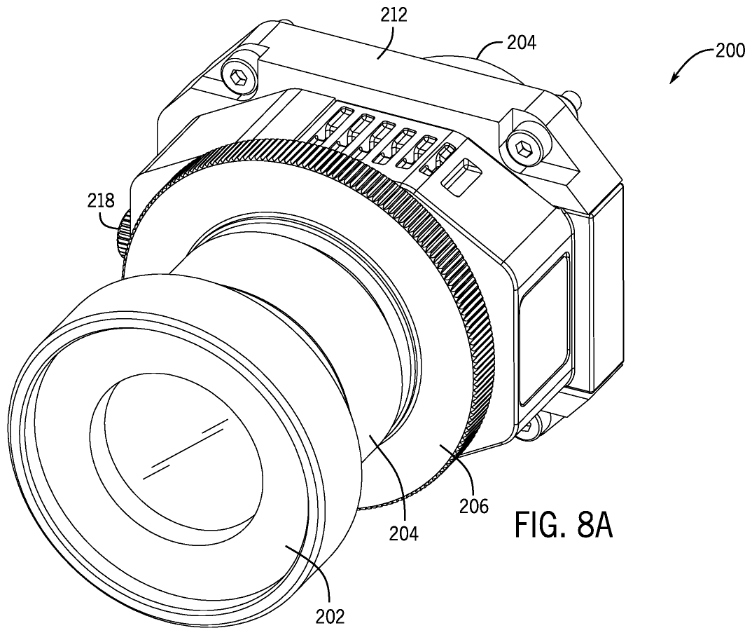

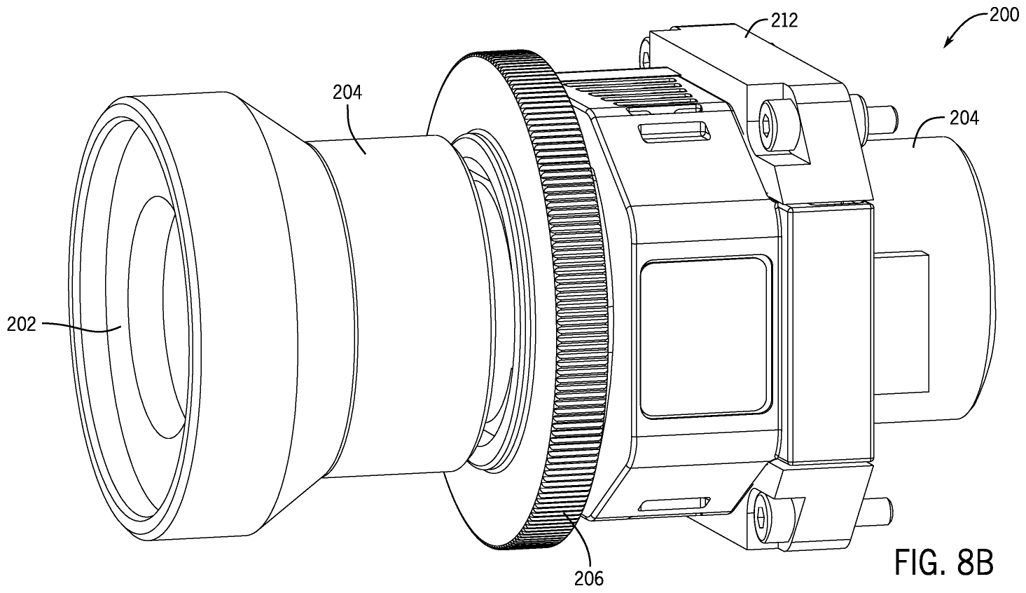

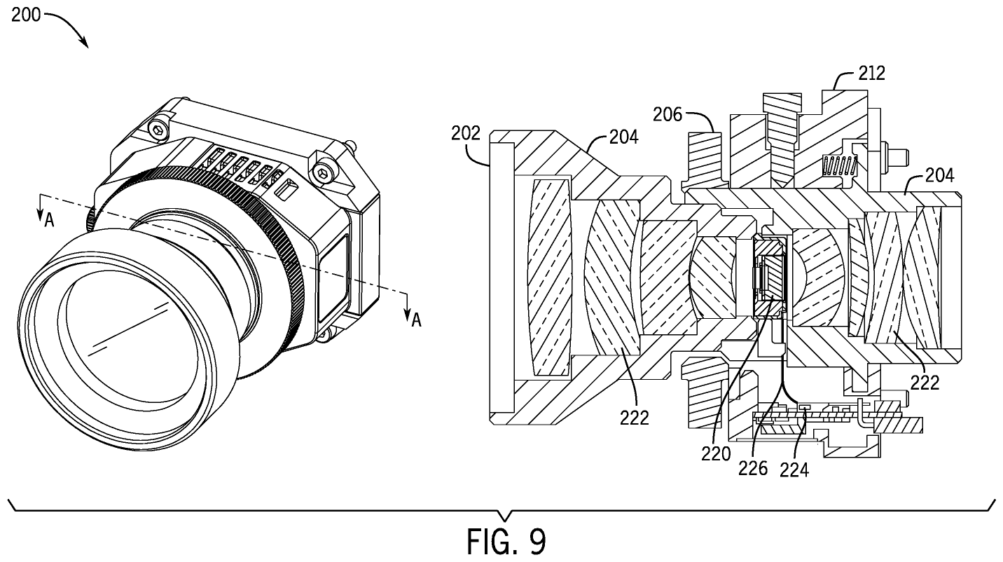

In some embodiments, the lens assembly may include one or more liquid lenses. FIG. 8A is a perspective view of a lens assembly for a machine vision system in accordance with an embodiment of the technology and FIG. 8B is a perspective view of the lens assembly of FIG. 8A in accordance with an embodiment of the technology. The lens assembly 200 in FIGS. 8A and 8B can include a cover 202, a barrel 204, a calibration ring 206, and a flange (e.g., a C-mount flange) 212. The cover 202, barrel 204, calibration ring 206, and flange 212 may be elements of a housing (e.g., housing 210 shown in FIG. 11) for the lens assembly 200. The barrel 204 can be configured to house a liquid lens 220 and solid lens elements 222 (e.g., glass lens elements) as shown in FIG. 9, discussed further below. In some embodiments, the barrel 204 can have a cylindrical shape. The cover 202 can be attached a first end of the barrel 204 and may be configured to be positioned in front of the liquid lens 220 and solid lens elements 222 (shown in FIG. 9) disposed in the barrel 204. The flange 212 can be disposed around the barrel 204 proximate to a second end of the barrel 204 and may be configured to be mounted to an image sensor assembly (e.g., image sensor assembly 240 discussed further below with respect to FIG. 11). Advantageously, lens assembly 200 can be modular and may be interchangeably attached to different image sensor assemblies.

The calibration ring 206 can be disposed around the barrel 204 and may be configured to cause linear movement of the barrel 204 when the calibration ring 206 is rotated about the barrel 204, for example, as discussed above with respect to FIGS. 4A and 4B. Advantageously, rotation of the calibration ring 206 can be configured to only cause linear movement of the barrel so that the liquid lens 220 and solid lens elements 222 within the barrel 204 do not rotate as the calibration ring 206 is rotated and the barrel 204 moves. In some embodiments, adjustment of the barrel 204 (and the liquid lens and solid lens elements disposed within the barrel 204) may be used to adjust and calibrate, for example, the back focal length of the lens assembly 200. In some embodiments, the barrel 204 and the calibration ring 206 may include corresponding thread elements that cause the barrel 204 to move linearly when the calibration ring 206 is rotated. In some embodiments, once the barrel 204 (and the liquid lens 220 and solid lens elements 222) has been placed in the desired position (e.g., as part of a calibrated process), the calibration ring 206 may be attached or affixed to the barrel 204 and/or or the barrel 204 may be attached or affixed to the flange 212. For example, known attachment mechanisms such as an adhesive may be used to attach the calibration ring 206 to the barrel 204 and/or to attach the barrel 204 to the flange 212 so that the barrel 204 remains in the desired position. In some embodiments, a setting screw 218 may be provided that may be configured to secure the barrel 204 in the desired position until the barrel is further affixed (e.g., using adhesive) to, for example, the calibration ring 206 and/or flange 212. For example, the setting screw 218 may be tightened to secure the barrel 204 in the desired position.

As discussed above with respect to FIG. 3, in some embodiments, the lens assembly 200 can include one or more positioning elements that may be configured to maintain the position of the barrel, e.g., to ensure the barrel 204 is in the correct position, to prevent backlash. In some embodiments, the positioning elements may be springs. In some embodiments, the positioning elements may be mounted to the barrel 204.

FIG. 9 is a cross-sectional view of the lens assembly of FIGS. 8A and 8B in accordance with an embodiment of the technology. In particular, FIG. 9 illustrates a cross-section of the lens assembly 200 along line A-A. It should be noted that the depicted arrangement of components is illustrative of a wide range of layouts and component types. This illustration is, thus, provided to teach a possible arrangement of components that provide the functions of the illustrative embodiment, although other embodiments can exhibit other configurations. As mentioned above, lens assembly 200 can include a cover 202, a barrel 204, a calibration ring 206, and a flange 212. The cover 202 can be positioned on a first end of the barrel 204 and in front of the liquid lens 220 and solid lens elements 222. The flange 212 can be disposed around the barrel 204 proximate to a second end of the barrel 204.

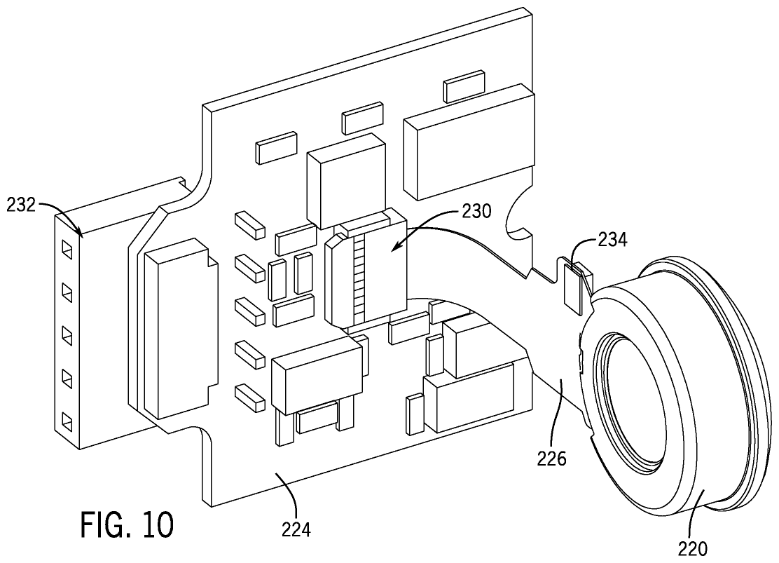

In some embodiments, a liquid lens 220 (or lenses) may be disposed in the barrel 204 and can be attached or mounted to the barrel 204. The liquid lens 220 can allow for rapid and automated adjustment of focus for images, for example, at different working distances. In some embodiments, the lens assembly 200 can also include a plurality of solid lens elements 222 (e.g., glass) disposed in the barrel 204. The solid lens elements 222 may be positioned either in front of the liquid lens 220, behind the liquid lens 220 or both in front of and behind the liquid lens 220. The plurality of solid lens elements 222 may also be attached to or mounted to the barrel 204. The liquid lens 220 can include an interface (or membrane) and the curvature of the interface (or membrane) can be adjusted based on the needs of the system (e.g., for a particular working distance). For example, in some embodiments the focal distance and the optical power of the liquid lens 220 may be adjusted by varying a control signal, for example, a voltage or current applied to the liquid lens 220 to change the curvature of the interface (or membrane) of the liquid lens 220. In some embodiments, the lens assembly 200 advantageously also includes processing components, for example, a lens processor 224, that can be advantageously positioned in the housing of the lens assembly 200. In some embodiments, the lens processor 224 may be implemented on a printed circuit board (PCB). The lens processor 224 may be coupled to and in communication with the liquid lens 220, for example, using a cable 226 or other communication channels (not shown). In some embodiments, a connector (e.g., connector 232 shown in FIG. 10) may be provided to enable the lens processor 224 to be coupled to and in communication with an image sensor assembly processor (not shown) when the lens assembly 200 is mounted to or attached to an image sensor assembly (not show) as discussed further below with respect to FIG. 11.

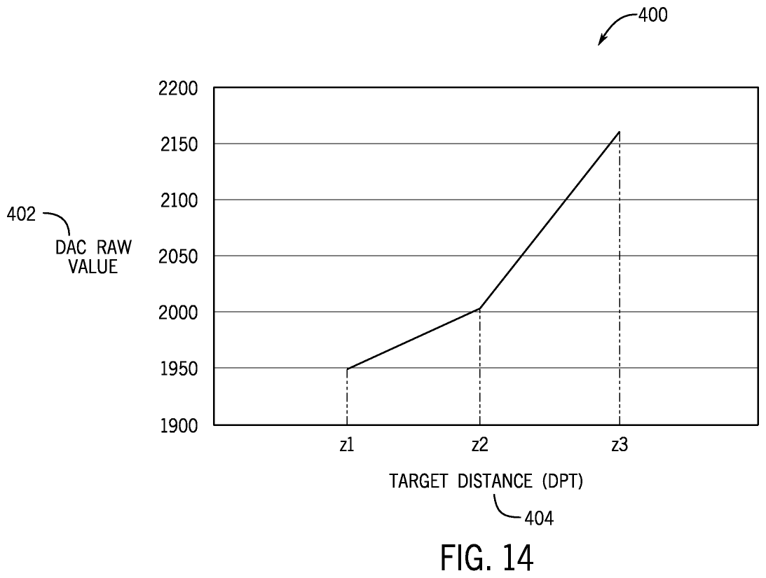

Advantageously, the lens processor 224 may be configured to perform various tasks such as, for example, correction of thermal drift of the liquid lens 220, flange compensation, other electrical and mechanical compensation, determining a control signal for the liquid lens, and controlling the liquid lens (e.g., adjustment of focal distance and optical power of the liquid lens). Accordingly, in some embodiments, such tasks and functions may be performed only by the lens processor 224 rather than on the image sensor assembly processor 246. In some embodiments, information such as, for example, calibration data for the lens assembly 200 and a thermal model may be stored in a memory or data storage (e.g., memory 236 shown in FIG. 11) associated with the lens processor 224 and also included on, for example, a printed circuit board in the lens assembly 200. In some embodiments, the calibration data can include a calibration temperature, autofocus information at a plurality of distances (or positions) for the liquid lens 220 (e.g., the drive current (or membrane curvature) of the liquid lens that produces a sharp image at a particular position of the liquid lens), etc. In some embodiments, the calibration data can include data regarding a calibration curve for the liquid lens 220 in the lens assembly 200 (e.g., a calibration curve as illustrated in FIG. 14) and a set of coefficients (kᵢ) modeling the interaction between the optical power of a machine vision system including the lens assembly 200, the temperature, and the input control signal for the liquid lens 220. In some embodiments, the set of coefficients (kᵢ) can include parameters that describe the thermal behavior of a machine vision system with temperature. In some embodiments, the calibration data for a lens assembly 200 may be determined at the manufacturer of the lens assembly and stored in memory of the lens assembly so that the calibration data can advantageously travel with the lens assembly 200 to a site where the lens assembly may be installed with an image sensor assembly (e.g., image sensor assembly shown in FIG. 11). Accordingly, in some embodiments, the calibration of the lens assembly 200 may be performed at the manufacturer of the liquid lens rather than the specific site where the image sensor assembly is located.

As mentioned above, the calibration ring 206 can be disposed around the barrel 204 and may be configured to cause linear movement of the barrel 204 and the solid lens elements 222 disposed within the barrel 204 when the calibration ring 206 is rotated about the barrel 204. Advantageously, the liquid lens 220 and the plurality of solid lens elements 222 do not rotate as the barrel 204 (and liquid lens 220 the solid lens elements 222) move linearly as the calibration ring 206 is rotated about the barrel 204. In some embodiments, adjustment of the barrel 204 (and the liquid lens and solid lens elements disposed within the barrel 204) may be used to adjust and calibrate, for example, the back focal length of the lens assembly 200. In some embodiments, the barrel 204 and the calibration ring 206 may include corresponding thread elements that cause the barrel 204 to move linearly when the calibration ring 206 is rotated. In some embodiments, when the lens assembly 200 is mounted to an image sensor assembly (e.g., image sensor assembly 240 shown in FIG. 11), rotation of the calibration ring 206 can linearly move the barrel 204 (and the liquid lens 220 and the plurality of lens elements 222) toward and away from an image sensor in the image sensor assembly.

As mentioned above, the lens assembly 200 advantageously includes a lens processor 224 disposed within the housing of the lens assembly 200. FIG. 10 shows a liquid lens and lens processor of the lens assembly of FIGS. 8A and 8B in accordance with an embodiment of the technology. In FIG. 10, the liquid lens 220 can be coupled to and in communication with the lens processor 224 using, for example, a cable 226. In some embodiments, the cable 226 may be directly connected (e.g., soldered) to the liquid lens 220. The cable 226 may also be connected to the lens processor 224 using a processor connector 230. In some embodiments, a connector 232 may be provided to enable the lens processor 224 to be coupled to and in communication with an image sensor assembly processor (not shown) when the lens assembly 200 (shown in FIGS. 8A-9) is mounted to or attached to an image sensor assembly as discussed further below with respect to FIG. 11. In some embodiments, a temperature sensor 234 may be positioned proximate to the liquid lens 220, for example, on the cable 226. The temperature sensor 234 may be configured to measure the temperature of the liquid lens 220. In some embodiments, the temperature sensor 234 is coupled to and in communication with the lens processor 224.

As mentioned above, lens assembly 200 is a modular assembly and can be interchangeably attached to different image sensor assemblies. Different models or types of liquid lenses may require different drivers, in particular, as more intelligent and advanced types of liquid lenses are developed. Image sensor assemblies may not have the proper drive software to support a particular type of liquid lens. Advantageously, by including a lens processor 224 in the lens assembly, the appropriate liquid lens driver software, optimizations, calibration data, etc., may be kept close to the liquid lens 220 and support more advanced liquid lens technologies. Accordingly, it may be simpler to move the lens assembly from one image sensor assembly to another. For example, the interface between the lens assembly and the image sensor assembly may be the same for any type of liquid lens and image sensor assembly. Because the driver, calibration data, and other data for the liquid lens 220 are provided on the lens assembly processor 224, the image sensor assembly may only be required to provide certain data (e.g., flange measurements or tolerances, a distance defining a desired optical power for the liquid lens, etc.) to the lens assembly 200 during operation. In addition, the image sensor assembly processor 246 (shown in FIG. 11) may also be simpler because it would not need to include the driver for the liquid lens or other data specific to the liquid lens such as calibration data. As mentioned above, by providing a memory (e.g., memory 236 shown in FIG. 11) in the lens assembly 200 that can be configured to store calibration data for the liquid lens 220, the calibration of the lens assembly 200 may be performed at the manufacturer of the liquid lens rather than the specific site where the image sensor assembly is located.

FIG. 11 is a block diagram of a machine vision system including a modular lens assembly in accordance with an embodiment of the technology. While FIG. 11 illustrates an embodiment of a vision system arrangement, it should be understood that the various embodiments described herein may be implemented on different types of vision system including, but not limited to, mobile (e.g., handheld) or fixed mount ID readers, inspection systems, etc. It should be noted that the depicted arrangement of components is illustrative of a wide range of layouts and component types. The illustrated embodiment is thus provided to teach a possible arrangement of components that provide the functions of the illustrative embodiment, although other embodiments can exhibit other configurations.

The machine vision system shown in FIG. 11 can include a modular lens assembly 200, an imager sensor assembly 240, an illumination assembly 260, and a distance sensor 262. The machine vision system may be used to acquire an image of, for example, an object 250, an exemplary target 252 (e.g., a symbol, an object feature (e.g., an edge), etc.) on the object 250 or to acquire an image to detect the presence of absence of the object 250. An image may be acquired by projecting an illumination light on the object 250 (e.g., via active or passive illumination from the illumination assembly 260) and receiving reflected light from the object 250. Thus, the lens assembly 200 is placed in front of the image sensor assembly 240, in particular, in front of the image sensor 244 of the image sensor assembly 240. The lens assembly 200 includes a series of lens elements that project the images' light onto the area of the image sensor 244 and, correspondingly, define a FOV for imaging with the image sensor 244. Light projected from the illumination assembly 260 that is reflected from the object 250 back to the machine vision system may be directed through the lenses of the lens assembly 200 along a reader optical axis to the image sensor 244 of the image sensor assembly 240. The reflected light is received by the image sensor 244 for processing (e.g., by image sensor assembly processor 246) to, for example, generate an image of the object 250. Known methods may be used for generating an image of the scene and detecting data therein.

The lens assembly 200 can include a lens housing 210, a liquid lens (or lenses) 220, a plurality of solid (e.g., glass) lens elements 222, a lens processor 224, a temperature sensor 234 and a memory 236. In some embodiments, the lens housing 210 may include various components such as, for example, a cover, a barrel, a calibration ring and a flange as discussed above with respect to FIGS. 8A-9. As mentioned above, in some embodiments a calibration ring (e.g., calibration ring 206 shown in FIGS. 8A-9) may be used to adjust the position of the barrel and the lenses (e.g., liquid lens 220 and solid lens elements 222) positioned within the barrel to set the back focal length of the vision system. For example, the calibration ring may be used to move the barrel and lenses toward or away from the image sensor 244 in the image sensor assembly 240 to adjust the distance between the lenses 220, 222 and the image sensor 244. The desired position of the barrel and lenses may be determined based on the needs and specific application (or applications) of the vision system. The lens housing 210 may be configured to allow the lens assembly 200 to be removably attached or mounted to a housing 242 of the image sensor assembly 240. Accordingly, the lens assembly 200 is modular and may be interchangeably attached to different image sensor assemblies.

In some embodiments, the solid lens elements 222 may be positioned either in front of the liquid lens 220, behind the liquid lens 220 or both in front of and behind the liquid lens 220. The liquid lens 220 and solid lens elements 222 may be used to project light reflected by the object 250 (or the target 252 on the object 250) onto the image sensor 244 of the image sensor assembly 240. The focal distance and the optical power of the of the liquid lens 220 can be adjusted by varying a current (or voltage) applied to the liquid lens 220 using, for example, the lens processor 224. In some embodiments, the liquid lens 220 can advantageously allow for the rapid and automated adjustment of focus for images based on the needs of the machine vision system, for example, for different working distances.

The lens processor 224 may be disposed within the lens assembly housing 210 and may be coupled to and in communication with the liquid lens 220. Advantageously, the lens processor 224 may be configured to perform various tasks and functions such as, for example, correction of thermal drift of the liquid lens 220 (i.e., thermal compensation), mechanical compensation (e.g., for mechanical tolerances of the vision system), electrical compensation (e.g., for electrical tolerances of the vision system), generating a control signal for the liquid lens, and controlling the liquid lens 220 (e.g., setting and adjusting focal distance and optical power of the liquid lens) as discussed further below. Accordingly, in some embodiments, such tasks and functions may be performed only by the lens processor 224 rather than on the image sensor assembly processor 246. In some embodiments, the lens processor 224 can include one or more processor devices that can be provided on one or more circuit boards and operatively interconnected by the appropriate ribbon cable(s) or other communication channels (not shown). In some embodiments, the lens processor 224 may also be coupled to and in communication with a temperature sensor 234. The temperature sensor 234 may be positioned proximate to the liquid lens 220 and may be configured to measure or detect the temperature of the liquid lens 220. In some embodiments, a memory 236 may also be included in the lens assembly 200. The memory 236 may be coupled to and in communication with the lens processor 224. In some embodiments, information such as, for example, calibration data for the lens assembly 200 and a thermal model may be stored in memory 236. In some embodiments, the calibration data can include a calibration temperature, autofocus information at a plurality of distances (or positions) for the liquid lens 220 (e.g., the drive current (or membrane curvature) of the liquid lens that produces a sharp image at a particular position of the liquid lens), etc. In some embodiments, the calibration data can include data regarding a calibration curve for the liquid lens 220 in the lens assembly 200 (e.g., a calibration curve as illustrated in FIG. 14) and a set of coefficients (kᵢ) modeling the interaction between the optical power of a machine vision system including the lens assembly 200, the temperature, and the input control signal for the liquid lens 220. In some embodiments, the set of coefficients (kᵢ) can include parameters that describe the thermal behavior of a machine vision system with temperature).

In some embodiments, the lens processor 224 may also be coupled to and in communication with an image sensor processor 246 in the image sensor assembly 240. For example, as discussed above with respect to FIG. 10, a connector (e.g., connector 232) may be used to connect the lens processor 224 to the image sensor assembly processor 246 when the lens assembly 200 is removably mounted to the image sensor assembly 240. In some embodiments, the image sensor assembly processor 246 may provide data (e.g., a desired distance (i.e., optical power), a distance measurement, a flange value, mechanical tolerances, electrical tolerances, etc.) to the lens processor 224 and receive data from the lens processor 224, for example, during operation of the vision system. As mentioned above, in some embodiments, the lens processor 224 may advantageously be configured to perform various tasks such as correction of thermal drift of the liquid lens 220 (i.e., thermal compensation), mechanical compensation (e.g., for mechanical tolerances of the vision system), electrical compensation (e.g., for electrical tolerances of the vision system), generating a control signal for the liquid lens, and controlling the liquid lens 220 (e.g., setting and adjusting focal distance and optical power of the liquid lens). Accordingly, in such embodiments the image sensor assembly processor 246 does not need to perform these functions and may only be needed to provide certain data to the lens processor 224.

In some embodiments, the image sensor assembly 240 includes a housing 242, an image sensor 244 and an image sensor assembly processor 246. In some embodiments, the image sensor 244 may be configured to detect different wavelengths of light or can also be configured to detect different polarizations of light. In some embodiments, the image sensor 244 can be a monochromatic sensor (e.g., black and white) or a color sensor. The reflected light from the object 250 that is projected through the lenses (e.g., liquid lens 220 and solid lens elements 222) of the lens assembly 200 may be received by the image sensor 244 for processing (e.g., by processor 246) to, for example, generate an image of the object 250. In some embodiments, the image sensor processor 246 may be coupled to and in communication with the image sensor 244, the lens processor 224, the illumination assembly 260, and distance sensor 262. The image sensor assembly processor 246 may be configured to control vision system tasks and analysis processes (e.g., ID reading and decoding, inspection) as well as other functions, including, but not limited to, illumination for image acquisition (e.g., timing or intensity of light, selection of a light source for illumination, etc.), determining a distance to the object 250, etc. Known methods may be used for generating an image of the scene and decoding data therein. In some embodiments, the image sensor assembly processor 246 can include one or more processor devices that can be provided on one or more circuit boards and operatively interconnected by the appropriate ribbon cable(s) or other communication channels (not shown). The image sensor assembly processor 246 may also be configured to wirelessly transmit (via a wireless link, not shown), for example, decoded data to a data handling device such as an inventory tracking computer or logistics application. Alternatively, the image sensor assembly processor 246 may be wired to a data handling device network or can store and subsequently transfer collected information when it is connected to a base unit.

The illumination assembly 260 may include one or more light sources, for example, one or more LEDs. In some embodiments, the illumination assembly 248 may be positioned in front of and, when assembled, coupled to the lens assembly 200. The illumination assembly can be configured to provide illumination, for example, light of particular wavelength bands centered on the visible spectrum, light of particular polarizations, etc. In some embodiments, the illumination assembly can include one or more LEDs or laser diodes to provide the illumination light (or light beam(s)). In some embodiments, the illumination assembly 248 can include a plurality of multispectral light sources that may be used to generate light in multiple wavelengths that may be projected onto an object 250 to, for example, acquire an image of the object 250 or an image of a target 252 on the object 250.

The distance sensor 262 may be configured to obtain distance data regarding an object 250 (e.g., distance to the object 250) to be imaged by the vision system. The distance sensor 262 may be, for example, a time of flight (TOF) sensor (or system) or other distance sensor. In some embodiments, the image sensor assembly processor 246 can be configured to receive distance data regarding the object 250 from the distance sensor 262. In some embodiments, the image sensor assembly processor 246 may be configured to determine a working distance between the object 250 and the lens assembly 200 based on the distance data acquired by the distanced sensor 262. In some embodiments, the image sensor assembly processor 246 may be configured to determine a working distance between the object 250 and the lens assembly 200 using other known techniques such as, for example, image analysis. In some embodiments, various constraints of the particular vision system application may be considered when determining the working distance to the object including, for example, a speed of the object on a conveyor, a curvature of the object, a size of the target 252 (e.g., an ID) on the object, etc. In some embodiments, the distance sensor may be coupled to an in communication with the lens processor 224 (as illustrated with a dotted line in FIG. 11). Accordingly, in such embodiments the distance sensor 262 may provide distance data to the lens processor 224 directly. In some embodiments, the distance sensor 262 may be incorporated into the lens assembly 200.

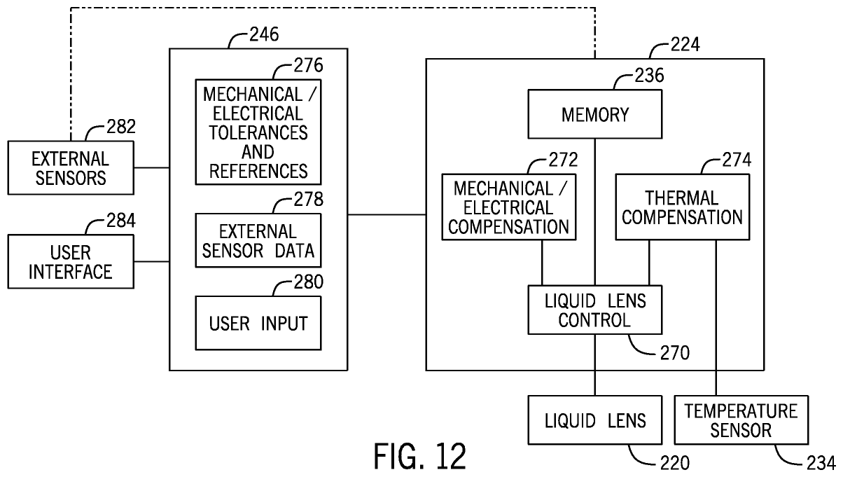

As mentioned above, the lens processor 224 may be advantageously configured to perform various tasks and functions including, but not limited to, correction of thermal drift of the liquid lens 220 (i.e., thermal compensation), mechanical compensation (e.g., for mechanical tolerances of the vision system), electrical compensation (e.g., for electrical tolerances of the vision system), generating a control signal for the liquid lens 220, and controlling the liquid lens 220 (e.g., setting and adjusting focal distance and optical power of the liquid lens). Accordingly, in some embodiments, such tasks and functions may advantageously be performed only by the lens processor 224 rather than on the image sensor assembly processor 246. FIG. 12 is a block diagram of a lens processor and an image sensor assembly processor of the machine vision system of FIG. 11 in accordance with an embodiment of the technology. While FIG. 12 illustrates an embodiment of arrangements of processor devices, it should be noted that the depicted arrangement of components is illustrative of a wide range of layouts and component types. The illustrated embodiment is thus provided to teach a possible arrangement of components that provide the functions of the illustrative embodiment, although other embodiments can exhibit other configurations.

In FIG. 12, the lens processor 224 includes a memory 236, a liquid lens control 270, mechanical/electrical compensation 272 and thermal compensation 274. In some embodiments, the liquid lens control 270 may be configured to determine a control signal (e.g., a control current) for the liquid lens 220 of the lens assembly (e.g., lens assembly 200 shown in FIG. 11) and to apply the control signal (e.g., a control current) to the liquid lens 220 to set the focus of the liquid lens (e.g., to provide a desired focal distance and optical power for the liquid lens 220 and the lens assembly 200). In some embodiments, the control signal may be determined so as to produce a desired or predetermined focus for the liquid lens 220. In some embodiments, the control signal may be determined so as to set the focus of the liquid lens 220 to produce a desired or predetermined optical power for the lens assembly 200. For example, calibration data for the lens assembly 200 may be used to determine an appropriate control signal to focus the liquid lens 220 and the lens assembly 200 to the given optical power of the lens assembly 200. In some embodiments, the control signal may be determined so as to set the focus of the liquid lens 220 based on a working distance to an object to be imaged. For example, the liquid lens control 270 may be configured to determine an optical power based on a measured working distance and then determine a control signal to produce the determined optical power.

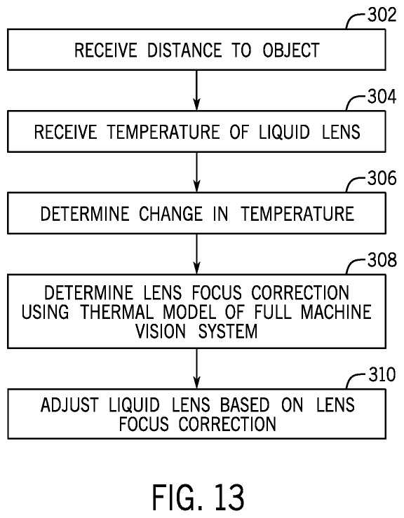

In some embodiments, the liquid lens control 270 may also be configured to take into account various compensation values when determining a control signal (e.g., a current) for the liquid lens 220. For example, the lens processor 224 may be configured to determine mechanical and electrical compensation 272 and thermal compensation 274 that may be provided to the liquid lens control 270 and used in the determination of the control signal for the liquid lens 220. In some embodiments, the mechanical and electrical compensation 272 can be configured to determine compensation values to account for various mechanical and electrical tolerances of a vision system, for example, for components of the vision system including the lens assembly 200, image sensor assembly 240, illumination assembly 260, etc. In some embodiments, the thermal compensation 274 may be configured to determine compensation values based at least on a temperature of the liquid lens 220 (e.g., as measured by a temperature sensor 234 in the lens assembly 200) to correct, for example, thermal drift of the liquid lens 220. In some embodiments, as discussed further below with respect to FIG. 13, the thermal compensation may be determined using a thermal model of the machine vision system that models the full system behavior with regard to temperature that includes mechanical and electrical parameters of the vision system as well as parameters of the liquid lens 220.

In some embodiments, the lens processor 224 may also be configured to perform self-assessment or diagnostic functions. For example, the lens processor 224 may be configured to determine if the control signals from the liquid lens control 270 are reaching the liquid lens 220. In another example, the lens processor 224 may be configured to determine or sense the electrical characteristics of the liquid lens 220 to perform a self-diagnostic feature. In some embodiments, the lens processor 224 may be configured to monitor connections to the liquid lens (e.g., open and short circuit). In some embodiments, the diagnostic functions performed by the lens processor 224 can generate an error signal that may be transmitted to, for example, the image sensor assembly processor 246.

Memory 236 of the lens processor 224 may be used to store various parameters utilized by the liquid lens control 270, mechanical/electrical compensation 272 and the thermal compensation 274. For example, as mentioned above, calibration data for the lens assembly 200 may be stored in memory 236. In some embodiments, the calibration data can include a calibration temperature, autofocus information at a plurality of distances (or positions) for the liquid lens 220 (e.g., the drive current (or membrane curvature) of the liquid lens that produces a sharp image at a particular position of the liquid lens), etc. In some embodiments, the calibration data can include data regarding a calibration curve for the liquid lens 220 in the lens assembly 200 (e.g., a calibration curve as illustrated in FIG. 14) and a set of coefficients (kᵢ) modeling the interaction between the optical power of a machine vision system including the lens assembly 200, the temperature, and the input control signal for the liquid lens 220. In some embodiments, the set of coefficients (kᵢ) can include parameters that describe the thermal behavior of a machine vision system with temperature). In some embodiments, the memory 236 may also be used to store a thermal model that may be used for thermal compensation as described further below with respect to FIG. 13. In some embodiments, various parameters utilized by the liquid lens control 270, mechanical/electrical compensation 272 and the thermal compensation 274 may be provided to the lens processor 224 from the image sensor assembly processor 246. In some embodiments, the image sensor assembly processor 246 may include (e.g., in a memory, not shown) mechanical and electrical tolerances and references 276 of the vision system (e.g., a flange value). In some embodiments, the image sensor assembly processor 246 may be configured to receive external sensor data 278 from external sensors 282 (e.g., a distance sensor 262, shown in FIG. 11) which may also be provided to the lens processor 224. In some embodiments, the external sensor data 276 may be provided directly to the lens processor 224 from external sensors 282 (as illustrated with dotted lines in FIG. 12). In some embodiments, the image sensor processor 246 may also be configured to receive user input data 280 from a user (or operator) via a user interface 284. The user input data 280 (e.g., start/stop instructions for the vision system) may also be provided to the lens processor 224.

In some embodiments, the image sensor assembly may provide a desired system optical power in the form of a distance, for example, a distance (mm) may be provided by a user as a user input 280 via a user interface 284. The lens processor 224 may be configured to convert the desired distance to an optical power in diopters. For example, the optical power in diopters may be determined by:

$$optical power = \frac{1}{distance} \qquad Eqn . 1$$

In some embodiments, the image sensor assembly processor 246 may provide a set or sequence of desired distances to the lens processor 224 rather than providing desired distances to the image assembly processor 224 one by one. The set or sequence of distances may be stored in memory 236 of the lens processor 224. Accordingly, the image sensor assembly processor 246 and the lens processor 224 do not need to be in constant communication during operation and can, therefore, avoid communication delays. The lens processor 224 may be configured to determine the next position (e.g., the next five positions). This feature can be advantageous, for example, as the speed of conveyors for various machine vision system applications get faster. In some embodiments, storing the sequence of distances on the lens processor 224 may also allow the lens processor 224 to avoid overshoot. In some embodiments, the image sensor assembly processor 246 may be configured to query the lens processor 224 to determine the type of liquid lens 220 included in the lens assembly 220 and the lens processor 224 may be configured to respond and provide information regarding the type of liquid lens in the lens assembly, for example, size, distances, focal length, etc., to the image sensor assembly processor 246. In some embodiments, the image sensor assembly processor 246 may be configured to use the information regarding the liquid lens in the lens assembly to determine if the liquid lens and lens assembly are appropriate for use with the image sensor 244 in the image sensor assembly 240. In some embodiments, the image sensor assembly processor 246 may be configured to use the information regarding the liquid lens and the lens assembly to optimize the tasks performed by the image sensor assembly processor 246.

As mentioned above, the lens processor 224 may be advantageously configured to perform correction of thermal drift of the liquid lens 220 (i.e., thermal compensation 274). The relationship between the optical power of the liquid lens 220 and the current applied to the liquid lens 220 can change with the temperature of the liquid lens. FIG. 13 illustrates a method for correcting thermal drift of a liquid lens in a lens assembly for a machine vision system in accordance with an embodiment of the technology. At block 302, a distance to the object (or target) to be image is received. For example, an image sensor assembly processor (e.g., processor 246 shown in FIGS. 11 and 12) can provide a distance to the object 250 to a lens processor (e.g., lens processor 224 shown in FIGS. 11 and 12). In some embodiments, the lens processor 224 may convert the distance to an optical power in diopters. At block 305, a temperature of the liquid lens may be received by, for example, a lens processor (e.g., lens processor 224) from a temperature sensor (e.g., temperature sensor 234 shown in FIGS. 11 and 12) in the lens assembly. At block 306, a change in the temperature of the liquid lens is determined, for example, a difference in the measured temperature of the liquid lens 220 and a calibration temperature (e.g., a calibration temperature stored in a memory 234 of the lens assembly 200) for the liquid lens (i.e., the temperature at which the calibration data for the liquid lens 220 was acquired). In some embodiments, known methods may be used to determine the temperature change of the liquid lens.

At block 308, if there is a change of temperature determined at block 306 (e.g., the liquid lens is not at the same temperature as the calibration temperature) a lens focus correction (or adjustment) may be determined using a thermal model of the full machine vision system. (e.g., by the thermal compensation 274 module of the lens processor 224 shown in FIG. 12) Accordingly, the thermal model advantageously can be configured as a statistical model of the full system behavior with regard to temperature that includes mechanical and electrical parameters of the vision system as well as parameters of the liquid lens. In some embodiments, the thermal model may be given by:

$$\frac{d {P}_{s y s}}{d T} = {\sum }_{i = 0}^{n} {k}_{i} {x}^{i} \qquad Eqn . 2$$

where dP_{sys} is a small optical power difference of the system relative to a reference optical power (P_{sys}, for example, the system optical power desired by a user and/or the image sensor assembly), dT is the temperature difference (e.g., determined at block 306) between a measured temperature of the liquid lens and a reference temperature (e.g., the calibration temperature), kᵢ is a set of one or more coefficients modelling the interaction between the system optical power, the temperature, and the input signal for the liquid lens, and x is the discrete input (e.g., current) for the liquid lens at a given optical power. dP_{sys} can represent (e.g., in diopters) how much the reference optical power (P_{sys}) needs to be corrected or offset based on the temperature of the liquid lens. As mentioned above, calibration temperature, thermal model and coefficients (kᵢ) may be stored in memory of the lens assembly (e.g., memory 236 shown in FIGS. 11 and 12). In some embodiments, the coefficients (kᵢ) are determined for the particular liquid lens 220 in the lens assembly 200. The coefficients kᵢ may be determined based on experimental data, for example, the coefficients could be determined as a statistical average of data from a plurality of the same type of liquid lens (e.g., the same model). The experimental data may represent all information that may possibly impact how the liquid lens curvature changes based on temperature. In an example, the thermal model for i=1 may be given by:

$$\frac{d {P}_{s y s}}{d T} = m * Raw + n \qquad Eqn . 3$$

where Raw (i.e., x¹) is a digital value that correlates to the driving electrical current that is applied to the liquid lens, and m (i.e., k₁) and n (i.e., k₀) are parameters that describe the thermal behavior of the machine vision system with temperature.

In some embodiments, the lens focus correction is an adjustment to the control signal (e.g., a current) applied to the liquid lens to produce an optical power that will generate an image that is in focus (i.e., a sharp image). In some embodiments, the thermal model may be used to determine (or solve for) dP_{sys} based on the determined temperature difference, dT, (e.g., as determined at block 306), the current input (xⁱ) for the liquid lens for the reference optical power (P_{sys}), and the coefficient (kᵢ). The calibration temperature and coefficient(s) (kᵢ) may be retrieved from memory (e.g., memory 236) of the lens processor 224. The value dP_{sys} may then be used to determine the lens focus correction based on the calibration data stored in memory of the lens assembly 200, for example, data related to a predetermined calibration curve for the liquid lens 220 in the lens assembly. FIG. 14 is an example calibration curve for a liquid lens in accordance with an embodiment. In FIG. 14, the calibration curve illustrates a relationship between Raw value (i.e., current) 402 and optical power 404 (in diopters) for a specific liquid lens. In some embodiments, the measurements used to create the calibration curve 400 are acquired at the same temperature, namely, the calibration temperature. In the example of FIG. 14, the curve 400 is determined using three distances which can fit non-linear behavior. In some embodiments, the calibration curve for a particular liquid lens may be generated using measurements for more than three distances. The adjusted system optical power for the identified temperature change, P_{sys}+dP_{sys}, may be compared to the calibration curve data to identify a corresponding current value. The lens focus correction can be the appropriate adjustment to the current input to the liquid lens that will generate the adjusted system optical power.

At block 310, the liquid lens may be adjusted based on the lens focus correction (e.g., by the liquid lens control 270 of lens assembly processor 224 shown in FIG. 12). For example, the lens processor (e.g., lens processor 224) may be used to adjust the control signal (e.g., current) applied to the liquid lens to adjust the focal length and optical power of the liquid lens.

As mentioned above, the lens processor 224 may also be configured to perform tasks related to mechanical compensation (e.g., for mechanical tolerances of the machine visions system). In some embodiments, the lens processor 224 may be configured to perform flange compensation. For example, the image sensor (e.g., image sensor 244 shown in FIG. 11) may move, or the distance to an object may vary because of mechanical tolerances of the image sensor assembly 242. In some embodiments, the image sensor assembly processor 246 may provide a flange measurement or tolerances to the lens processor 224 so a correction or an adjustment to the system optical power may be determined based on the flange measurement or tolerances.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above-described steps of the processes of FIG. 13 can be executed or performed in any order or sequence not limited to the order and sequence shown and described in the figures. Also, some of the above steps of the processes of FIG. 13 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for correcting thermal drift of a liquid lens in a lens assembly for a machine vision system, the method comprising:
receiving a distance to an object;
receiving a temperature measurement for the liquid lens;
determining a change in temperature for the liquid lens;
determining a lens focus adjustment using a thermal model of the machine vision system, wherein the thermal model includes mechanical and electrical parameters of the machine vision system; and
adjusting a focal length of the liquid lens based on the lens focus adjustment.

2. The method according to claim 1, wherein the thermal model is given by:
$$\frac{d {P}_{s y s}}{d T} = {\sum }_{i = 0}^{n} {k}_{i} {x}^{i} ,$$
where dP_{sys} is an optical power difference of the machine vision system relative to a reference optical power, dT is the change in temperature for the liquid lens relative to a reference temperature, kᵢ is a set of coefficients modelling the interaction between a system optical power, a temperature, and an input signal for the liquid lens, and x is a discrete input for the liquid lens at a given optical power.

3. The method according to claim 1, wherein adjusting the focal length of the liquid lens comprises:
determining a control current based on the lens focus adjustment; and
applying the control current to the liquid lens.

4. The method according to claim 2, wherein determining the lens focus adjustment using the thermal model comprises:
determining the optical power difference dP_{sys} using the thermal model; and
comparing the determined optical power difference dP_{sys} to a predetermined calibration curve for the liquid lens to identify the lens focus adjustment.

5. The method according to claim 4, wherein the predetermined calibration curve includes a relationship between current and optical power for the liquid lens and the predetermined calibration curve is determined using a plurality of distances that fit non-linear behavior.

6. A modular lens assembly for a machine vision system, the modular lens assembly comprising:
a lens housing;
a liquid lens disposed within the lens housing;
a solid lens element disposed within the lens housing; and
a lens processor device disposed within the lens housing and coupled to the liquid lens, the lens processor device configured to determine a control signal to control the liquid lens.

7. The modular lens assembly according to claim 6, wherein the lens processor device is further configured to determine at least one of mechanical compensation, electrical compensation, or thermal compensation for the control of the liquid lens.

8. The modular lens assembly according to claim 7, further comprising a temperature sensor disposed within the lens housing and proximate to the liquid lens and wherein determining the thermal compensation comprises correcting thermal drift of the liquid lens.

9. The modular lens assembly according to claim 6, wherein the lens housing is configured to be coupled to an image sensor assembly comprising an image sensor assembly housing, an image sensor, and an image sensor assembly processor device disposed within the image sensor assembly housing.

10. The modular lens assembly according to claim 6, wherein the control signal comprises a current applied to the liquid lens.

11. The modular lens assembly according to claim 6, wherein the control signal is determined by the lens processor device based on a predetermined focus for the liquid lens.

12. The modular lens assembly according to claim 6, wherein the control signal is determined by the lens processor device based on a working distance to an object.

13. The modular lens assembly according to claim 7, wherein the control signal is determined based on at least one of the mechanical compensation, electrical compensation, or thermal compensation.

14. The modular lens assembly according to claim 8, further comprising a cable connected to the liquid lens and the lens processor device and wherein the temperature sensor is positioned on the cable proximate a connection point between the cable and the liquid lens.

15. The modular lens assembly according to claim 6, wherein the lens housing comprises:
a barrel having an outer surface; and
a calibration ring disposed around the outer surface of the barrel and configured to cause linear movement of the barrel when the calibration ring is rotated.

16. The modular lens assembly according to claim 15, further comprising a positioning element coupled to the barrel and configured to maintain a position of the barrel.

17. The modular lens assembly according to claim 6, wherein the lens processor device is configured to perform a diagnostic function for the liquid lens.

18. The modular lens assembly according to claim 17, wherein the diagnostic function comprises generating an error signal in response to detection of an open circuit or a short circuit corresponding to the liquid lens.

19. A lens assembly for a machine vision system, the lens assembly comprising:
a lens housing comprising:
a barrel having an outer surface; and
a calibration ring disposed around the outer surface of the barrel and configured to cause linear movement of the barrel when the calibration ring is rotated;
a plurality of lens elements disposed within the barrel; and
a positioning element coupled to the barrel and configured to maintain a position of the barrel.

20. The lens assembly according to claim 19, wherein the positioning element comprises a plurality of springs.

21. The lens assembly according to claim 19, wherein the calibration ring is configured to adjust a back focal length.

22. The lens assembly according to claim 19, wherein the plurality of lens elements includes a solid lens element.

23. The lens assembly according to claim 19, further comprising:
a locker ring disposed around the calibration ring;
a locking apparatus; and
an O-ring disposed between the calibration ring and the locker ring.

24. The lens assembly according to claim 23, wherein the locking apparatus comprises:
a first visual indicator on the locker ring;
a catch on the locker ring;
a second visual indicator on the calibration ring; and
a recess positioned on the calibration ring.

25. The lens assembly according to claim 24, wherein the locker ring is configured to be moved linearly to engage the calibration ring in response to an alignment of the first visual indicator and the second visual indicator.

26. The lens assembly according to claim 25, wherein the catch on the locker ring is configured to engage the recess on the calibration ring in response to the locker ring moving linearly.

27. The lens assembly according to claim 25, wherein rotation of the locker ring drives rotation of the calibration ring when the locker ring is engaged with the calibration ring.

28. The lens assembly according to claim 24, wherein the locker ring is configured to be moved linearly to disengage from the calibration ring in response to an alignment of the first visual indicator and the second visual indicator.

29. The lens assembly according to claim 28, wherein the catch is configured to disengage from the recess on the calibration ring in response to the locker ring moving linearly.

30. The lens assembly according to claim 28, wherein the locker ring is configured to rotate separately from the calibration ring in response to the locker ring being disengaged from the calibration ring.

31. The lens assembly according to claim 19, wherein the plurality of lens elements includes a liquid lens.
